(19) United States
(12) Patent Application Publication
(10) Pub. No.: US 2025/0170583 A1
(43) Pub. Date: May 29, 2025

(54) SYSTEM AND METHOD FOR RECOVERING DESIRED MATERIALS USING A BALL MILL OR ROD MILL

(71) Applicant: Thomas A Valerio, Atlanta, GA (US)

(72) Inventor: Thomas A Valerio, Atlanta, GA (US)

(21) Appl. No.: 18/759,764

(22) Filed: Jun. 28, 2024

Related U.S. Application Data
(63) Continuation-in-part of application No. 17/478,408, filed on Sep. 17, 2021, now abandoned.
Application No. 17/478,408 is a continuation of application No. PCT/US2020/023456, filed on Mar. 18, 2020.
(60) Provisional application No. 62/820,015, filed on Mar. 18, 2019.

(51) Int. Cl. B03B 9/00; B03B 9/04; B03B 9/06

(52) U.S. Cl. CPC B03B 9/00; B03B 9/04; B03B 9/061

(57) ABSTRACT

A method for recovering metals from waste, in which the material is screened to produce a nonfibrous feedstock. The nonfibrous feedstock is then comminuted using a mill (e.g., a ball mill or rod mill) to liberate, flatten, and separate it, resulting in a mixture of a metal fraction and a residue. The metal fraction and residue are subsequently collected. A system employing this method is also described for treating such materials.

### CROSS-REFERENCE TO RELATED APPLICATION

This application is a continuation-in-part of U.S. patent application Ser. No. 17/478,408, which is a continuation of U.S. Patent Application No. PCT/US20/023456, filed Mar. 18, 2020, which claims the benefit of priority to U.S. Provisional Patent Application No. 62/820,015, filed Mar. 18, 2019, each which is incorporated by reference herein in its entirety.

### TECHNICAL FIELD

This application relates to systems for separating desired materials from waste such as automotive shredder residue (ASR), electronic waste, incinerator ash, and the like. More specifically, the application describes a system for recovering ferrous and nonferrous materials by reducing the size of the waste material to facilitate the separation process.

### BACKGROUND

Millions of tons of municipal solid waste are produced every year. Waste management and utilization strategies are major concerns in many countries. Incineration is a common technique for treating waste, as it can reduce waste mass by 80% and volume by up to 90%, while also allowing the recovery of energy from waste to generate electricity.

This application recognizes that systems using ball mills are part of the prior art, such as in WO Publication No. WO/2020/006007, titled “METHOD, PROCESS, AND SYSTEM OF USING A MILL TO SEPARATE METALS FROM FIBROUS FEEDSTOCK.” The publication discloses a method for recovering metals from waste where material is roughly or coarsely separated to leave a fibrous feedstock. The feedstock is comminuted with a mill (e.g., a ball mill) to liberate and separate the fibrous feedstock, resulting in a mix of a metal fraction and residue, which are then collected.

To utilize incinerator waste and reduce environmental impact, various treatment methods have been introduced, and the waste has been classified and separated to promote recovery. There is a continuous need for improved methods for separating and classifying incinerator waste, including incinerator combined ash.

### SUMMARY

This application discloses a system and method for recovering metals, such as ferrous and nonferrous metals, to address the issue of metal wastage. The invention also focuses on separating metals from nonmetals.

One aspect includes a method for recovering metals from metal-based waste. This method involves separating fibrous materials from the metal-based waste to leave a non-fibrous feedstock, comminuting the non-fibrous feedstock with a ball or rod mill to liberate, flatten, and separate the metals from the non-fibrous feedstock to obtain a mix of a metal fraction and residue. The method further includes separating the non-fibrous feedstock into residue and a metals fraction using density separation or mechanical separation, and collecting the metals fraction and the residue. The segregating step can employ a density separator. The method can also include separating ferrous metals from the waste stream using a magnetic drum and separating light and heavy materials using a rougher. Additionally, the method can involve reusing water by cleaning it through a water treating assembly or circuit. The rougher can consist of a density separator and a mechanical separator for distinguishing between heavy and light materials.

Another aspect is a system comprising a screening assembly to remove fibrous material from a waste stream, a ball mill or rod mill, a mechanical separator, and a density separator. A rough concentrate assembly can be associated with the rougher for polishing the heavy materials present in the waste stream. The rough concentrate assembly may include a sand wheel, an eddy current chamber, and a high-pressure slurry pump for separating non-ferrous materials from the waste stream. A density separator can be connected to the ball mill for separating materials using specific gravity. Certain embodiments may also include an eddy current chamber for separating nonferrous materials, a sand scrubber for detaching different types of materials, and a washing jet for removing sand from the materials.

Another aspect includes a method or system for treating a waste stream that is a mixture of automotive shredder residue, electronic waste, incinerator ash, and similar materials.

Yet another aspect is a system for recovering metals from a waste stream, comprising a feeder to hold the waste stream, a star screen for size separation, a ball mill associated with the star screen to grind or flatten the waste stream, a falling velocity separator/density separator connected to the ball mill for sorting organic and inorganic materials present in the waste stream, a wet magnetic drum coupled to the falling velocity separator/density separator to separate ferrous materials from the waste stream, a rougher attached to the wet magnetic drum for sorting light and heavy materials, and a water treatment assembly connected to the rougher for reusing water utilized in the system.

While the invention has been described and shown with particular reference to the preferred embodiment, it will be apparent that variations might be possible that would fall within the scope of this application.

### BRIEF DESCRIPTION OF THE DRAWINGS

FIG. 1 illustrates a block diagram of the system for recovering metal from a waste stream;

FIG. 2 illustrates a block diagram of the method for recovering metal from a waste stream; and

FIG. 3 shows an exemplary water recovery circuit that may be used with specific embodiments of this invention.

### DETAILED DESCRIPTION

This application discloses a system and method to recover metals from a waste stream. Specific applications include methods and systems related to the recovery of metals from both wet and dry processes. Such wet processes may include streams from preconcentrators, water table concentrators, gold shaking tables produced by Diester, Wilfley table concentrators, sink-float tanks, sink-float vessels, snail drums, barrel washers, wet processes using heavy media, DMS separators, hydro-cyclones, and other processes. Dry processes may include roughers such as an air aspirator or Z box aspirator, which are broadly used in the EU for pre-concentrating automobile shredder residue. Other wet and dry processes are known to those skilled in the art.

This invention also provides a method to separate ferrous and nonferrous materials. In some embodiments, the waste stream is automobile shredder residue. In other embodiments, the waste stream is ash, incinerator ash, or combined bottom ash.

Generally, this disclosure relates to systems and methods for reclaiming, recovering, and obtaining desired materials from a waste stream containing metals using a ball mill 105 or a rod mill at high capacity and low operational cost. The ball mill 105 or rod mill liberates embedded metals and uniformly flattens the shapes of the particles, allowing these materials to be further reclaimed with lower losses based on shape and density. In general, the waste stream can be automotive shredder residue (ASR), electronic waste, or incinerator ash. Water or other liquids can be used to separate portions of the material streams.

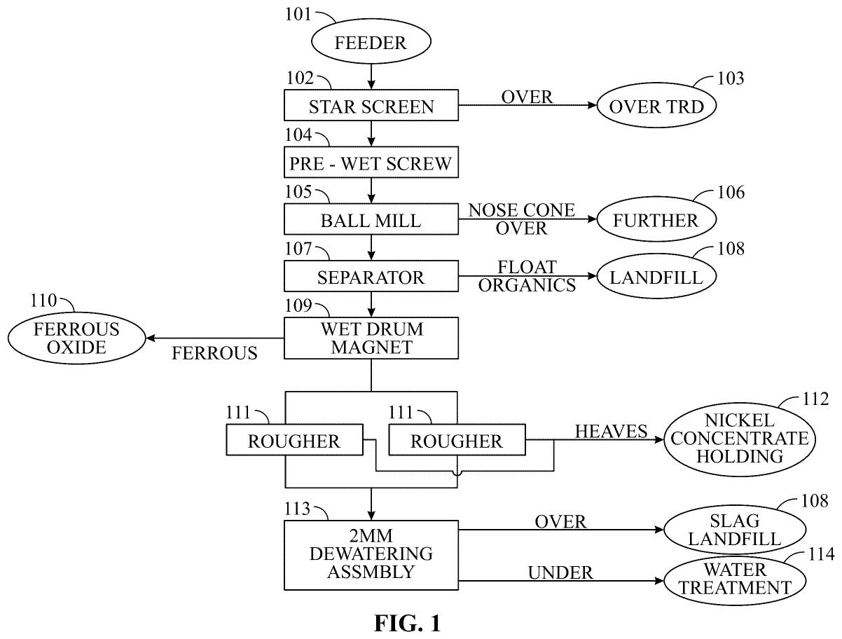

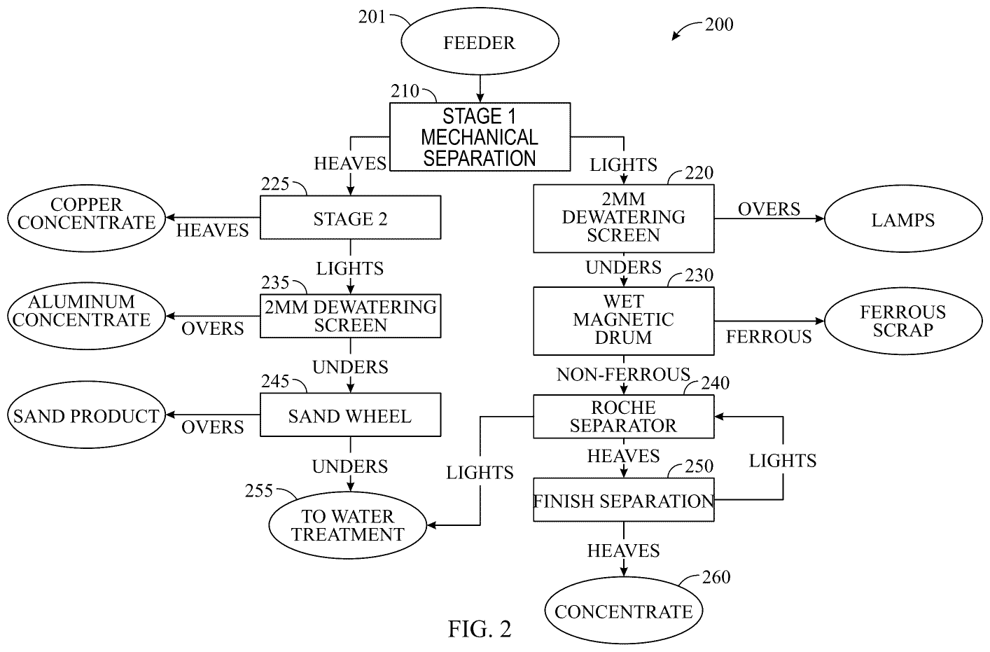

FIG. 1 illustrates an exemplary system 100 for separating incinerator or combined ash to obtain desired materials. A batch feeder 101 dispenses incinerator ash, ASR, or other similar waste containing various sizes of materials into a screen 102 or other processing method to remove fibrous material (e.g., the process 200 shown in FIG. 2). The screen 102 allows materials about 2 millimeters (mm) or smaller to pass through. Materials greater than about 2 mm can be removed from the system 100 for further manual and/or automatic processing 103. In this example, materials less than 2 mm can be sent to a size reducer 105, which comminutes the material. The size reducer 105 may be a ball mill (e.g., a wet-rubber ball mill) or a similar apparatus capable of reducing the size of the materials. A density separator 107 may be used to remove organics or organic material. Upon reduction, the material is sent to a magnet 109 to remove ferrous oxide and/or for further processing. Crushing, pulverizing, flattening, and grinding lead to size reduction or “comminution.” The comminuted material may be conveyed to a size separator that fractionates the material by size to produce two or more sized waste streams (e.g., at least an over fraction and an under fraction). Comminution (e.g., shredding or grinding) may be carried out to improve the efficiency of size and density separation. Roughers 111 may be used to remove heavies, and a 2 mm dewatering screen 113 may be used to separate the material into overs and unders. The overs may be sent to a landfill 108, and the unders may be collected and dewatered.

In one example, a screen 102 (e.g., star screen) can be operatively attached to the feeder 101. The screen 102 aperture is a barrier made up of crisscrossed thin wires of fiber material, making the screen flexible and ductile. The screen 102 may consist of tiny pores smaller than 2 mm, which separate minute materials from the waste stream. Generally, these particles are organic. Particles larger than 2 mm move to a ball mill 105 for grinding. In other examples, the screen sizes are greater than 4 mm, 6 mm, 8 mm, or 12 mm.

The feeder 101 dispenses the waste stream containing various sizes of materials into the initial screen (e.g., a star screen or any other screen). The initially screened material may run more efficiently through the process or system, protecting the rod mill or ball mill 105. Materials in batch or continuous can be sent to a wet or dry ball mill 105 or rod mill. In certain examples, the ball or rod mill is wet and may be rubber-lined. This process liberates the entangled and embedded metals and materials. In one example, the ball mill 105 or rod mill can flatten the particles, making them more buoyant for rising current systems. The metals, particularly malleable metals, from the ball mill 105 or rod mill are flattened.

From the ball mill 105 or rod mill, the material can be discretely sized or separated. For example, any device capable of making multiple size cuts can be used, such as 0-2 mm, 2-6 mm, 6-18 mm, 18-54 mm, and 54-100 mm.

From the ball or rod mill 105, the material can eventually proceed to a density separator 107 (e.g., falling velocity separator, rising current separator, or a jig) or further screened (e.g., using a nose cone). In one example, the materials are separated, making a cut at approximately 1.6 Specific Gravity (SG). In one example, the organic material or non-metallic material may be removed and discarded or used for solidification (e.g., absorbing wet or hazardous materials at landfill 108) or as inorganic media.

In one example, associating the ball mill 105 with the screen 102 at a size greater than 2 mm creates an unexpected result. The inner surface of the ball mill 105 is covered with rubber and is used for size reduction of the waste stream materials. The ball mill 105 also separates small and large-sized waste stream materials. Generally, the ball mill 105 has a cylindrical shape that rotates around a horizontal axis, with an internal cascading effect that reduces the material to a fine powder. The ball mills 105 operate by being fed from one end and discharged from the other end.

The heavier materials with the metal or minerals are eventually processed by a magnetic separator (e.g., a wet magnet) 109. Exemplary magnetic pulleys include low, medium, and high-intensity pulleys. At the magnetic pulley(s), ferrous 110 containing materials are removed from a product stream, leaving non-ferrous materials and minerals within the processing stream.

A density separator 107 can be connected or operatively connected to the ball mill 105. The density separator 107 has an inlet and outlet for input and output of the waste stream materials for further processing. The density separator separates materials by specific gravity using a paddle wheel. The paddle wheel, attached to the center-top portion of the density separator, rotates to generate water disturbance, facilitating the separation of heavy and light materials. The paddlewheel speed may vary at every process, ranging from 30 to 60 rpm.

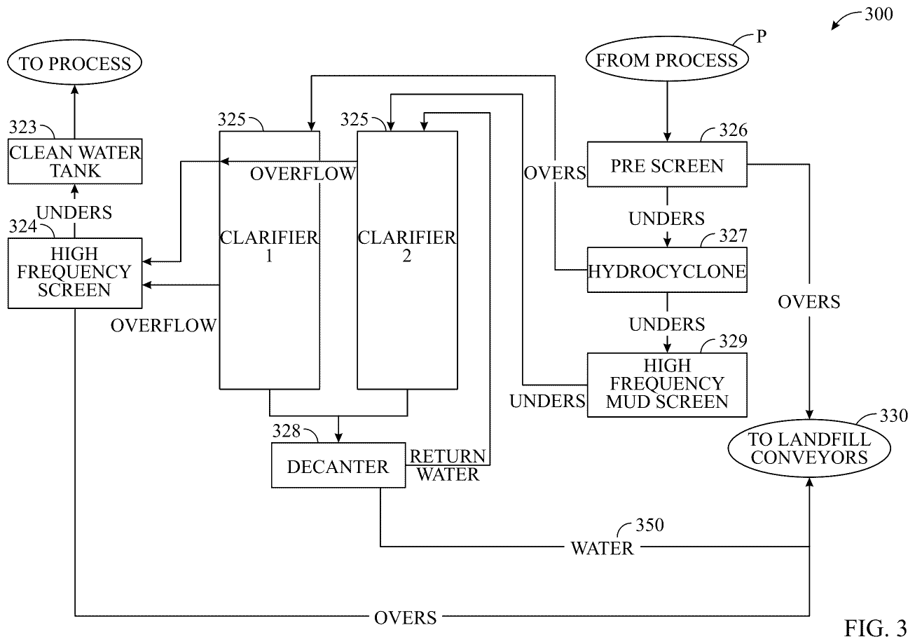

The material with the ferrous 110 removed is then processed through one or more roughers (e.g., jig or concentration tables, or wet or dry density separation). The heavies are further polished, and the lights are further processed and screened. This process divides mids from heavies. Mids can contain aggregate minerals and light metals (e.g., magnesium, aluminum). Part of the material may be processed as shown in FIG. 3.

A falling velocity separator or a density separator 107 is connected to the ball mill 105 for sorting organic materials from the waste stream left after the star screen 102. The falling velocity separator 107 separates heavy and light particles from the waste stream, operating at approximately 1.6 specific gravity. The waste stream of size 2-6 mm is separated by the density of materials. The materials with lower than 1.6 specific gravity are discarded in a landfill, while materials greater than 1.6 specific gravity are considered ferrous 110 and nonferrous.

Specific gravity, known as relative density, is the ratio of the measured substance's density to the reference density. The falling velocity separator 107 operates at specific gravity ranging from 1 to 1.6. Materials less than 1.6 are inorganic and get separated from the waste stream, while materials more than 1.6 are considered ferrous 110 and nonferrous. The materials with high specific gravity move to a wet magnetic drum 109 for separation of ferrous 110 materials from the waste stream.

After passing the waste stream through the wet magnetic drum 109, the waste stream is left with only nonferrous materials. These materials may contain heavy and light materials that are separated by a rougher 111. The rougher 111 can be a mechanical separator, density separator, or mechanical separator (e.g., separator by physical motion), where a table (e.g., WO2019222558—FLUIDIZED INERTIA TABLE) or mechanical separator can be used to separate material from the waste stream. The mechanical separator 116 is used to separate light material from the waste stream.

The density separator 107 consists of a rough density separator that separates light and heavy material from the waste stream. The heavy material is further processed in a finish mechanical separator (e.g., WO2018090039—METHOD AND SYSTEM FOR RECOVERING METAL USING A HELIX SEPARATOR). The finish density separator 117 is placed after the rough density separator 111, sorting heavy material while light material is processed again in the rough density separator 111 or mechanical separator. The heavy materials may include copper, aluminum, magnesium, or other nonferrous materials.

A number of dewatering screens 113 can be installed in the system. The dewatering screen 113 can be used to eliminate oversized material and is similar to the star screen 102. The dewatering screen 113 passes the oversized material to a landfill 108. After sorting the light and heavy material, the light material moves towards a rougher 111 concentrate assembly 112. The pore size in the dewatering screen 113 is 2 mm. Material smaller than 2 mm passes further, while material larger than 2 mm is eliminated to the landfill 108.

The rough concentrate assembly 112 can be associated with the rougher 111. The rough concentrate assembly 112 further separates light materials and consists of a sand scrubber. The sand scrubber produces friction in the light materials to separate inorganic materials 121 attached to ferrous 110 and nonferrous materials in the waste stream. The sand scrubber is essentially a wide rotating wheel with multiple pockets holding sand particles to scrub the light materials. After passing through the sand scrubber, the waste stream materials split into ferrous 110 and nonferrous materials. Sand particles may stick to ferrous 110 and nonferrous materials. A high-pressure slurry pump is used to remove the sand particles.

The high-pressure slurry pump is a hydro-cyclone used to eliminate sand particles from ferrous 110 and nonferrous materials. The high-pressure slurry pump may consist of a dewatering screen 113 for draining water and collecting it in a return box. The water collected in the return box is filtered for reuse. An eddy current chamber is used for further separation of nonferrous materials from the waste stream.

The “mids” or mid-sized materials may be processed using eddy current or sensor, which removes aluminum. The drops from the eddy current are aggregates and have commercial value as an aggregate product (e.g., asphalt or road bedding). In one example, a sand washer or sand wheel can be used to dewater and further polish the material.

An eddy current is induced by changing the magnetic field, flowing in closed loops. The eddy current is perpendicular to the plane of the magnetic field and is created upon moving a conductor through a magnetic field, producing a change in intensity or direction of the magnetic field.

The heavies or heavy metals (e.g., copper, brass, zinc, lead, stainless steel, cadmium, etc.) can be further processed and graded.

As shown in FIG. 2, a batch feeder 201 dispenses materials to a first separation screen 102, where the materials are separated using a mechanical separator 210. Such separators may be wet concentrating tables. The heavies are concentrated 225, and the lights are screened and dewatered using a 2 mm dewatering screen 235. In one example, the light fraction may be further treated with a sand washer 245. A sand washer 245 includes a sand wheel or other sand separators. The sieve screen apertures in the sand washer allow it to function as a dewatering device. One example of a sand separator is a sand washing machine with parts including: wheel sand washer, high-frequency dewatering screen, high-pressure cyclone separator, cleaning tank, return box, high-pressure slurry pump, motors, and associated pumps. The lights from the mechanical separator 210 can be screened using a dewatering screen 220, and the unders are processed using a magnetic drum 230. The heavies can be concentrated and dewatered. The lights from the magnetic drum 230 go to a rough separator 240; the heavies can be further processed using the rough separator 240 and then finished using a finish separator 250.

The undersize from process 100 shown in FIG. 1 can also be further processed in the process 300 shown in FIG. 3, allowing for the collection of water and concentration of waste material or market-worthy materials. FIG. 3 illustrates an exemplary system for separating a waste stream capable of reclaiming desired materials. The configuration of the system components shown in the figures results in the production or reclamation of media (e.g., inorganic materials under 200 mesh), sand and aggregates, metals, and solidification materials for landfills 108.

Buoyancy is the force that causes objects to float, exerted on an object partly or wholly immersed in a fluid. Buoyancy is caused by differences in pressure acting on opposite sides of an object immersed in a static fluid, also known as the buoyant force. An object immersed in a liquid experiences an upward force, known as buoyant force. Pressure in the fluid column increases with depth, and the pressure at the bottom of an object submerged in the fluid is greater than the force on the top. The difference in pressure results in a net upward force on the object, defined as buoyancy.

A water treatment assembly 324, shown in FIG. 3, can be connected to the sorting unit 325. The water treatment assembly 325 is used for the separation of remaining light materials and reusing water utilized in the system. The water treatment assembly 325 is a water treatment module with a clean water storage tank. It separates materials by specific gravity. Heavy and light materials have the same specific gravity in the recovered water as in the density separator. Materials with high specific gravity are metals, and materials with low specific gravity are nonmetals. The water treatment assembly 325 is based on the principle of buoyancy force.

FIG. 3 shows that the water and lights may be treated through the use of screens, concentrators (e.g., hydro-cyclones 327), and clarifiers 325. Goals include recovering water, reducing waste going to landfills 108, and producing solidification media and/or aggregate.

The clarifier 325 comprises a water treatment assembly 325 for cleaning water to reuse, further comprising a pre-screen 326 for filtering the water. The overflow from the clarifier goes to the high-frequency screen 324. A layer cleaning assembly connected to the clarifier 325 separates heavy and light particles. A refining assembly mounted on the clarifier 325 removes light particles to obtain clean water. A hydro-cyclone 327 attached to the refining assembly cleans the material, passing it to the high-frequency mud screen 329 for eliminating impurities. A velocity separation assembly mounted on the clean water tank extracts heavy particles, and a decanter 328 connected to the velocity separation assembly settles heavy particles, allowing clean water reuse.

In one embodiment, the system and method incorporate the water circuit as a closed loop. Generally, the paste from the dewatering device or decanter 328 may be conveyed and used as part of media for the system or method, reducing further waste. The clarified water can be stored and reused. The method includes screening fibers out of the material using a screen less than 2 mm, pulverizing or flattening the material using a ball mill 105 or rod mill, and further processing the material.

Although specific embodiments of the disclosure have been described above in detail, the description is merely for illustration purposes. It is to be understood that the present description illustrates aspects of the invention relevant to a clear understanding. Certain aspects that would be apparent to those skilled in the art and would not facilitate a better understanding of the invention have not been presented to simplify the description. Although embodiments have been described, one skilled in the art will recognize that many modifications and variations of the invention may be employed. All such variations and modifications are intended to be covered by the foregoing description.

1. A system for processing incinerator ash or automobile shredder residue (ASR) to recover metals, comprising:
a feeder for dispensing waste materials into a screen, wherein the screen configured to allow materials to pass through and direct larger materials;
a size reducer connected to the screen, wherein the size reducer is a ball mill;
a density separator for removing organic materials from the size-reduced waste stream; and
a magnetic separator for removing ferrous oxide from the processed waste stream.

2. The system of claim 1, wherein the screen is a star screen with apertures less than 2 mm.

3. The system of claim 1, wherein the ball mill is rubber-lined for comminution efficiency.

4. The system of claim 1, further comprising a dewatering screen for removing oversized material.

5. The system of claim 1, wherein the feeder dispenses waste stream material in batch or continuous mode.

6. The system of claim 1, further comprising a wet magnetic drum for separating ferrous materials from non-ferrous materials.

7. The system of claim 1, wherein the specific gravity separator includes a paddle wheel for creating water disturbance to aid in material separation.

8. A method for separating metals from incinerator ash or automobile shredder residue (ASR), comprising:
using a batch feeder to dispense waste materials into a screen, which separates materials based on size;
comminuting materials smaller than 2 millimeters using a ball mill;
employing a density separator to separate organic materials from the comminuted waste stream;
utilizing a magnetic separator to extract ferrous materials from the size-reduced and density-separated waste stream; and
directing materials with high specific gravity to roughers to further remove heavy materials and separate them into overs and unders using a 2 mm dewatering screen.

9. The method of claim 8, wherein the screen used is a star screen with apertures smaller than 2 mm.

10. The method of claim 9, wherein the ball mill is operated in a wet mode to enhance the separation process.

11. The method of claim 9, further comprising the step of using a wet magnetic drum to remove ferrous materials from the waste stream.

12. The method of claim 9, wherein the roughers include mechanical separators for light and heavy material separation.

13. The method of claim 9, further comprising the step of using a high-pressure slurry pump to eliminate sand particles from the separated materials.

14. The system of claim 9, wherein the ball mill flattens particles to enhance buoyancy for rising current systems.

15. The method of claim 9, wherein the separated light and heavy materials are further processed using a sand scrubber to detach inorganic materials.

16. The method of claim 9, further comprising the step of reusing water in the system by cleaning it through a water treatment assembly.

17. A system for processing incinerator ash or automobile shredder residue (ASR) to recover metals, comprising:
a batch feeder for dispensing waste materials into a screen, wherein the screen configured to allow materials about 2 millimeters or smaller to pass through and direct larger materials for further processing;
a size reducer connected to the screen, wherein the size reducer is a wet-rubber ball mill;
a density separator for removing organic materials from the size-reduced waste stream;
a magnetic separator for removing ferrous oxide from the processed waste stream

18. The system of claim 17, further comprising:
A rougher connected to the magnetic separator for further separating the heavy materials, wherein the rougher is configured to polish the heavies and remove light materials, subsequently directing the processed materials to a 2 mm dewatering screen; wherein the dewatering screen configured to separate the material into overs and unders, where the overs are sent to a landfill and the unders are collected and further processed.
